(19) United States
(12) Patent Application Publication
(10) Pub. No.: US 2012/0131266 A1
(43) Pub. Date: May 24, 2012

(54) MEMORY CONTROLLER, DATA STORAGE SYSTEM INCLUDING THE SAME, METHOD OF PROCESSING DATA

(75) Inventors: Kyoung Lae CHO, Yongin-Si (KR); Kwang Ho Kim, Hwaseong-si (KR); Jun Jin Kong, Yongin-Si (KR); Jin Kyu Kim, Seoul (KR)

(73) Assignee: Samsung Electronics Co., Ltd., Suwon-si (KR)

(21) Appl. No.: 13/301,961

(22) Filed: Nov. 22, 2011

(30) Foreign Application Priority Data
Nov. 22, 2010 (KR) 10-2010-0115944

(51) Int. Cl. G06F 12/00

(52) U.S. Cl. 711/103; 711/154; 711/E12.008

(57) ABSTRACT

A data storage system includes a controller configured to receive data and data information about the data from a host, analyze the data information, detect whether the data has been compressed, and compress the data according to a detection result; and a nonvolatile memory device configured to store the data compressed by the controller and information about whether the data has been compressed. The controller includes a buffer configured to temporarily store the data and the data information received from the host, an analyzer configured to output, based on an analysis result, a compression control flag that indicates whether the data has been compressed, and a compressor configured to selectively compress or bypass the data based on the compression control flag, and to transmit the data to the nonvolatile memory device.

### CROSS-REFERENCE TO RELATED APPLICATIONS

This application claims priority under 35 U.S.C. §119(a) from Korean Patent Application No. 10-2010-0115944 filed on Nov. 22, 2010, the disclosure of which is hereby incorporated by reference in its entirety.

### BACKGROUND OF THE INVENTION

1. Field of the Invention

The present invention relates to a data storage system, and more particularly, to a memory controller for detect whether input data has been compressed, a data storage system including the same, and a method of processing data

2. Description of the Related Art

A data storage system, such as a NAND flash memory system, a solid state disk or drive (SSD), divides input data into blocks when reading or writing it. In other words, when an upper layer commands that a nonvolatile memory device store a single data set having a plurality of blocks, a lower layer sends a write command when transmitting each of the blocks in the single data set. Accordingly, since neither the number of blocks included in the single data set nor whether continuously input blocks form the single data set is not known, the data storage system cannot detect whether input data has been compressed.

Therefore, when the data storage system includes a compressor, the data storage system performs compression with respect to all of the input data. In this case, if compressed data is input to the data storage system, the compressed data is compressed again. Consequently, the effect of compression is reduced and the volume of data may be increased

### SUMMARY

Some exemplary embodiments of the present general inventive concept provide a memory controller and a data storage system capable of efficiently performing data compression and reducing its operating time by compressing or bypassing the data based on a detection of whether the data has been compressed.

Some exemplary embodiments of the present general inventive concept provide a method of processing data capable of efficiently performing data compression and reducing its operating time by compressing or bypassing the data based on a detection of whether the data has been compressed in a data storage system.

According to some exemplary embodiments of the present general inventive concept, a data storage system is provided that may include a controller configured to receive data and data information about the data from a host, analyze the data information, detect whether the data has been compressed, and compress the data according to a detection result; and a nonvolatile memory device configured to store the data compressed by the controller and information about whether the data has been compressed. The controller may include a buffer configured to temporarily store the data and the data information received from the host, an analyzer configured to output, based on an analysis result, a compression control flag that indicates whether the data has been compressed and a compressor configured to selectively compress or bypass the data based on the compression control flag, and to transmit the data to the nonvolatile memory device.

The compressor may include a register configured to store the compression control flag output from the analyzer; a selector configured to bypass and transmit the data to the nonvolatile memory device in response to the compression control flag stored in the register when it is detected that the data has been compressed and to output the data to an internal component of the compressor in response to the compression control flag when it is detected that the data has not been compressed; and a processor configured to compress the data output from the selector using a predetermined compression algorithm and to transmit the compressed data to the nonvolatile memory device.

According to other exemplary embodiments of the present general inventive concept, a memory controller is provided that may include a buffer configured to temporarily store data received from a host, an analyzer configured to analyze data information about the data received from the host and detect whether the data has been compressed based on a result of the analysis, and a compressor configured to selectively compress or bypass the data based on a result of the detection of the analyzer, and to transmit the data to a nonvolatile memory device where the data is stored therein.

According to other exemplary embodiments of the present general inventive concept, a method of processing data may include receiving data and data information from a host; analyzing the data and the data information to determine whether the data has been compressed, when it is determined that the data has not been compressed, compressing the data using a predetermined compression algorithm and transmitting the compressed data to a nonvolatile memory device, and when it is determined that the data has been compressed, transmitting the data to the nonvolatile memory device.

According to other exemplary embodiments of the present general inventive concept, the data may include a header having a reserved field and an address field. In this case, the analyzing of the data and the data information may also include analyzing one of the reserved field and the address field to determine whether the data has been compressed.

According to other exemplary embodiments of the present general inventive concept, the data may include a header having a reserved field and an address field, the address field includes entropy information, and wherein the analyzing of the data and the data information may include comparing a value of the entropy information with a predetermined entropy reference value; and the determination of whether the data has been compressed is may be based on the comparison of the value of the entropy information and the predetermined entropy value.

According to other exemplary embodiments of the present general inventive concept, a data processing method may include receiving a tag of the data. In this case, the analyzing of the data and the data information may include analyzing the tag of the data to determine whether the data has been compressed.

According to other exemplary embodiments of the present general inventive concept, the data may include a plurality of bytes, a portion of the plurality of bytes of the data may include information indicating whether the data has been compressed, and wherein the analyzing of the data and the data information may include analyzing the portion of the plurality of bytes of the data to determine whether the data has been compressed.

The methods of the various exemplary embodiments of the general inventive concept may be realized by executing, for example, a computer program for performing the method, which is stored in a computer readable recording medium.

Additional aspects and advantages of the present general inventive concept will be set forth in part in the description which follows and, in part, will be obvious from the description, or may be learned by practice of the general inventive concept.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of an electronic system according to some embodiments of the present invention;

FIG. 2 is a schematic block diagram of a data storage system according to some embodiments of the present invention;

FIG. 3A is a schematic block diagram showing a compressor illustrated in FIG. 2 according to some embodiments of the present invention;

FIG. 3B is a schematic diagram showing the structure of a nonvolatile memory device illustrated in FIG. 2;

FIGS. 4A and 4B are diagrams for explaining an analyzer illustrated in FIG. 3A;

FIG. 5 is a diagram of a header illustrated in FIG. 4A according to some embodiments of the present invention;

FIG. 6 is a diagram of a reserved field in the header illustrated in FIG. 5 according to some embodiments of the present invention;

FIG. 7 is a diagram of an address field in the header illustrated in FIG. 5 according to some embodiments of the present invention;

FIG. 8 is a diagram of an address field in the header illustrated in FIG. 5 according to other embodiments of the present invention;

FIG. 9 is a flowchart of a method of processing data according to some embodiments of the present invention;

FIGS. 10A and 10B are flowcharts of methods of processing data according to other embodiments of the present invention;

FIGS. 11A is a diagram for explaining a method of processing data according to further embodiments of the present invention;

FIGS. 11B and 11C are flowcharts of the method illustrated in FIG. 11A;

FIG. 12 is a block diagram showing a modified example of the compressor shown in FIG. 3A;

FIG. 13 is a block diagram of an electronic system including a data storage system according to some embodiments of the present invention;

FIG. 14 is a block diagram of an electronic system including a data storage system according to other embodiments of the present invention; and

FIG. 15 is a block diagram of a computer system including a data storage system according to some embodiments of the present invention.

### DETAILED DESCRIPTION OF THE EXEMPLARY EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

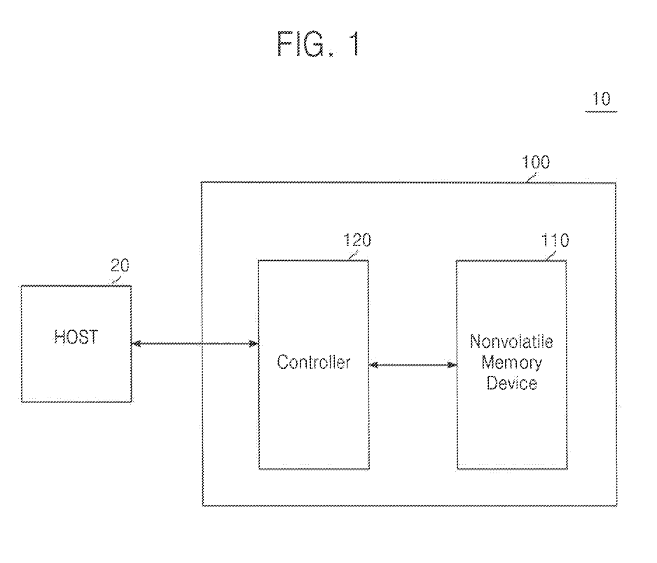

FIG. 1 is a schematic block diagram of an electronic system 10 according to some embodiments of the present invention. The electronic system 10 includes a data storage system 100 and a host 20. The data storage system 100 may include a controller 120 and a nonvolatile memory device 110.

The host 20 may communicate with the data storage system 100 using an interface protocol such as a peripheral component interconnect-express (PCI-E) protocol, an advanced technology attachment (ATA) protocol, a serial ATA (SATA) protocol, a parallel ATA (PATA) protocol, or a serial attached SCSI (SAS) protocol. However, the interface protocol between the host 20 and the data storage system 100 is not restricted to the above examples and may be one of other interface protocols such as a universal serial bus (USB) protocol, a multi-media card (MMC) protocol, an enhanced small disk interface (ESDI) protocol, and an integrated drive electronics (IDE) protocol.

The data storage system 100 may be, for example, a solid state drive (SSD) or a memory card (e.g., a secure digital (SD) card or an MMC), but the general inventive concept is not restricted to the exemplary embodiments. The nonvolatile memory device 110 may be, for example, a flash memory device but is not restricted thereto. For example, the nonvolatile memory device 110 may be a phase-change random access memory (PRAM) device, a magnetoresistive RAM (MRAM) device, a resistive RAM (ReRAM) device, or a ferroelectric RAM (FeRAM) device. When the nonvolatile memory device 110 is a flash memory device, it may be, for example, a NAND flash memory device using floating-gate technology or charge trap flash (CTF) technology. Memory cell transistors may be arranged in, for example, two or three dimensions in the nonvolatile memory device 110.

The controller 120 controls the overall operation of the data storage system 100 and controls the overall data exchange between the host 20 and the nonvolatile memory device 110. For instance, the controller 120 controls the nonvolatile memory device 110 to write or read data at the request of the host 20. The controller 120 also controls a series of internal operations (e.g., performance adjustment, merging, and wear leveling) needed for the characteristics of nonvolatile memory or for efficient management of the nonvolatile memory.

The nonvolatile memory device 110 is a storage for storing data in a nonvolatile manner. It may store, for example, an operating system (OS), a variety of programs, and diverse types of data.

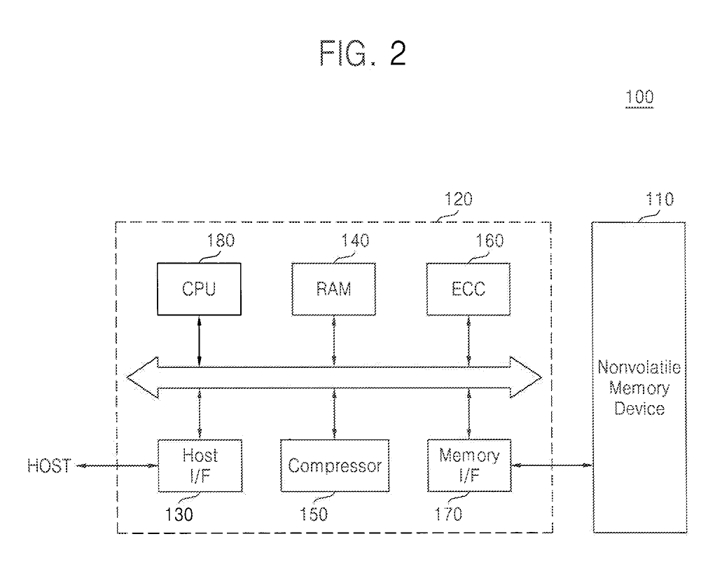

FIG. 2 is a schematic block diagram of the data storage system 100 according to some exemplary embodiments of the general inventive concept. The data storage system 100 includes the controller 120 which controls data exchange between the host 20 and the nonvolatile memory device 110. The controller 120 may include a host interface 130, a RAM 140, a compressor 150, an error correcting code (ECC) block 160, a memory interface 170, and a central processing unit (CPU) 180.

In operation, the host 20 sends an operation command (e.g., a read command, a program command, or an erase command), an address, and data to the host interface 130. The host interface 130 may include a data exchange protocol of the host 20 connected with the data storage system 100.

The RAM 140 may be used as an operation memory of the CPU 180 and may be implemented by a dynamic RAM (DRAM) or a static RAM (SRAM). The RAM 140 may also function as a buffer memory and temporarily store data transmitted from the host 20.

The compressor 150 compresses data or bypasses data to the nonvolatile memory device 110 based on data information received from the host 20. The data information is information that is used in detecting whether the data has been compressed. For instance, the data information may be information directly indicating whether the data has been compressed, information about the attributes of the data (hereinafter, referred to as “data attribute information”), or entropy information.

The ECC block 160 detects and corrects errors in data that has been read from the nonvolatile memory device 110 or data that is to be written to the nonvolatile memory device 110.

The memory interface 170 interfaces with the nonvolatile memory device 110.

The CPU 180 performs overall control for a data exchange operation of the controller 120. Although not shown, it will be apparent to those of ordinary skill in the art that the data storage system 100 may also include a read-only memory (ROM) storing code data for interfacing with the host 20.

The nonvolatile memory device 110 may store, for example, data compressed by the compressor 150 and information about whether the data has been compressed and/or may store data bypassed by the compressor 150 and information about whether the data has been compressed. The nonvolatile memory device 110 may be implemented by, for example, a NAND flash memory device including a memory cell array (not shown) including a plurality of memory cells.

Compressed data and information about whether the data has been compressed may be stored in a single page in the nonvolatile memory device 110. An ECC for performing error correction coding may also be stored in the single page.

The information about whether the data has been compressed may be stored as a 1-bit value. For example, when data that has not been compressed is stored in the page, “0” may be stored in the page, or when data that has been compressed is stored in the page, “1” may be stored in the page. However, the general inventive concept is not restricted to this example.

When the controller 120 reads data from the nonvolatile memory device 110, it may read the information about whether the data has been compressed together with the data from the nonvolatile memory device 110 and bypass the data to the host 20 or decompress the data before transmitting it to the host 20 based on the information about whether the data has been compressed.

In the error correction coding, an ECC corresponding to data is generated when the data is written to the nonvolatile memory device 110, the ECC stored in an ECC area is read when the data is read, and an ECC operation is performed for error detection.

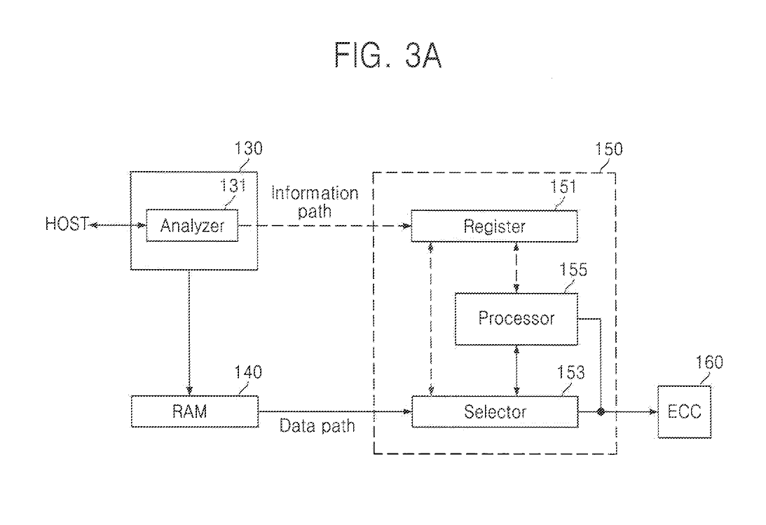

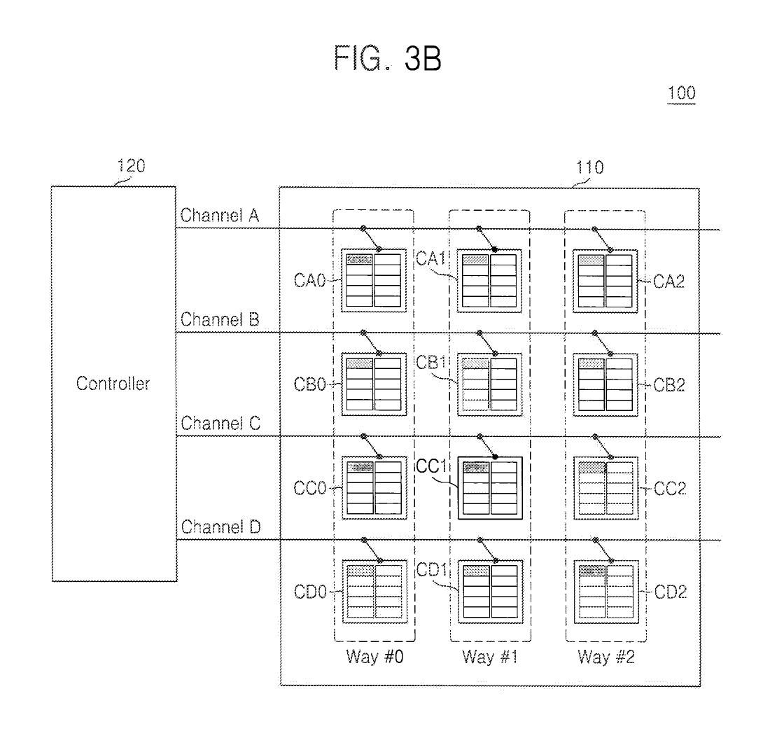

FIG. 3A is a schematic block diagram showing the compressor 150 illustrated in FIG. 2 according to some exemplary embodiments of the general inventive concept. Referring to FIGS. 1 through 3A, the host interface 130 may include an analyzer 131 and the compressor 150 may include a register 151, a selector 153, and a processor 155.

The host interface 130 analyzes data transmitted from the host 20 using the analyzer 131. The analyzer 131 outputs a compression control flag indicating whether the data has been compressed to the compressor 150 through an information path based on a result of analyzing the attributes of the data.

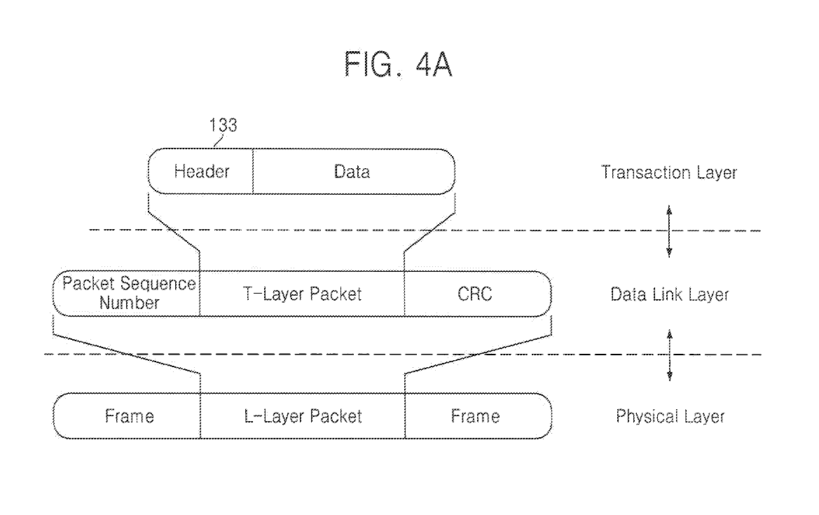

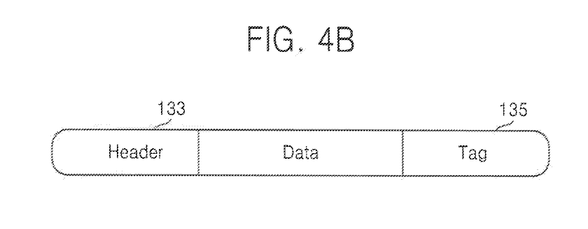

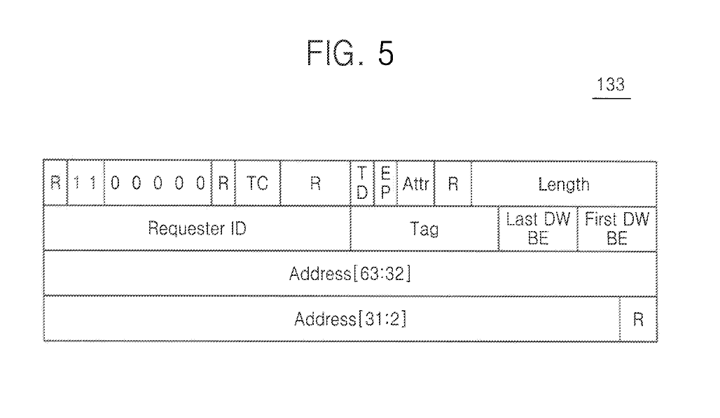

In detail, the analyzer 131 may analyze the attributes of data transmitted from the host 20 using the PCI-E protocol in order to detect whether the data has been compressed. An example of a method of analyzing the attributes of data is illustrated in FIGS. 4A through 5.

FIGS. 4A and 4B are diagrams for explaining the analyzer 131 illustrated in FIG. 3A. FIG. 5 is a diagram of a header illustrated in FIG. 4A according to some embodiments of the present invention. Referring to FIGS. 4A through 5, PCI-E interface includes a transaction layer, a data link layer, and a physical layer.

The transaction layer includes data and a header 133 of the data. The header may include data attribute information. As illustrated in FIG. 5, the header 133 includes a reserved field R that may be used by a user and an address field. The data attribute information may be stored in the reserved field R or the address field in the header 133. Alternatively, the data attribute information may be stored in a tag (or a footer) 135 of the data, as illustrated in FIG. 4B.

Referring back to FIG. 3A, the analyzer 131 may analyze the attributes of data based on header information, tag information, or address information transmitted from the host 20 in order to detect whether the data has been compressed.

In detail, when the analyzer 131 finds that the header information indicating whether the data has been compressed is included in the reserved field R in the header 133 as a result of analyzing the reserved field R, it detects whether the data has been compressed based on the header information and outputs a compression control flag to the register 151 according to a detection result.

When the analyzer 131 finds that the address information indicating whether the data has been compressed is included in the address field in the header 133 as a result of analyzing the address field, it detects whether the data has been compressed based on the address information and outputs a compression control flag to the register 151 according to a detection result.

When the address information has entropy information, the analyzer 131 compares a value of the entropy information with a predetermined reference value and outputs the compression control flag to the register 151 according to a comparison result.

When the analyzer 131 finds that the tag information indicating whether the data has been compressed is included in the tag 135 as a result of analyzing the tag 135, it outputs a compression control flag about whether the data has been compressed to the register 151 based on the tag information.

In other exemplary embodiments, the information about whether data has been compressed or the data attribute information may be included in the data. In this case, the analyzer 131 analyzes a particular bit or a particular plurality of bits in the data to detect whether the data has been compressed.

The register 151 stores a compression control flag received from the analyzer 131. For example, the register 151 may store a current compression control flag until a subsequent compression control flag is received from the analyzer 131.

The selector 153 receives a compression control flag from the register 151, detects whether the data has been compressed, bypasses the data to the ECC block 160 when it is detected that the data has been compressed, and outputs the data to the processor 155 of the compressor 150 when it is detected that the data has not been compressed.

In other words, the selector 153 may receive data temporarily stored in the RAM 140 via a data path, receive a compression control flag corresponding to the data from the register 151, transmit the data to the ECC block 160 when it is detected that the data has been compressed based on the compression control flag, and transmit the data to the processor 155 when it is detected that the data has not been compressed.

The processor 155 compresses data received from the selector 153 using a lossless compression algorithm. The compressed data is transmitted to the nonvolatile memory device 110 through the ECC block 160 and then stored in the nonvolatile memory device 110. When the lossless compression algorithm is used, original data is completely restored from compressed data. Examples of the lossless compression algorithm are a deflate algorithm, a Huffman algorithm, an arithmetic coding algorithm, and a Lempel-Ziv-Welch (LZW) algorithm.

FIG. 3B is a schematic diagram showing the structure of the nonvolatile memory device 110 illustrated in FIG. 2. In the data storage system 100, the controller 120 and the nonvolatile memory device 110 are connected through four channels A, B, C, and D. Three flash memory elements CA0 through CA2, CB0 through CB2, CC0 through CC2, or CD0 through CD2 are connected to a corresponding one of the channels A, B, C, and D. The nonvolatile memory device 110 may include a plurality of memory elements.

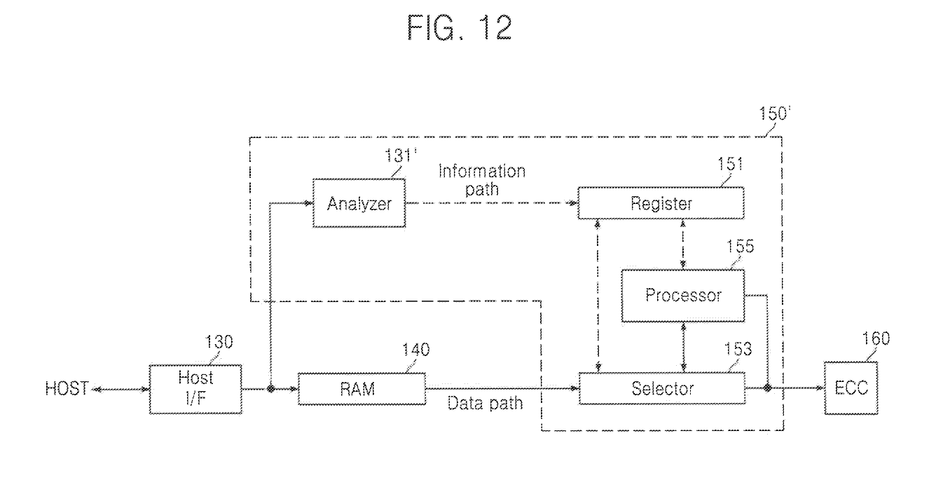

Although FIG. 3B shows the exemplary embodiments in which the nonvolatile memory device 110 has a hardware structure using 4-channel 3-way, the general inventive concept is not restricted thereto. For example, the data storage system 100 may use the structure of 4-channel 8-way. In the data storage system 100 having a hardware structure, the compressor 150 and a compressor 150′ (FIG. 12) may be provided for each channel, but the present invention is not restricted thereto.

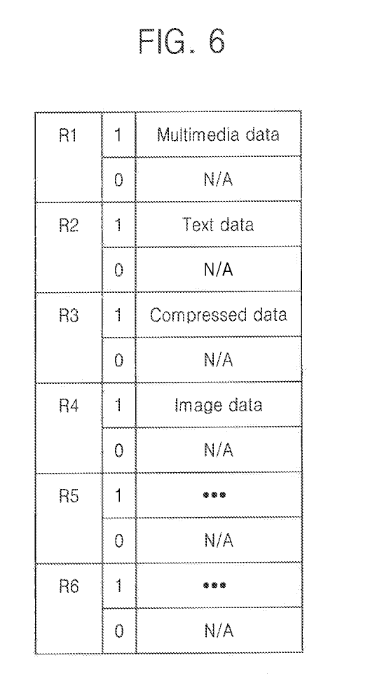

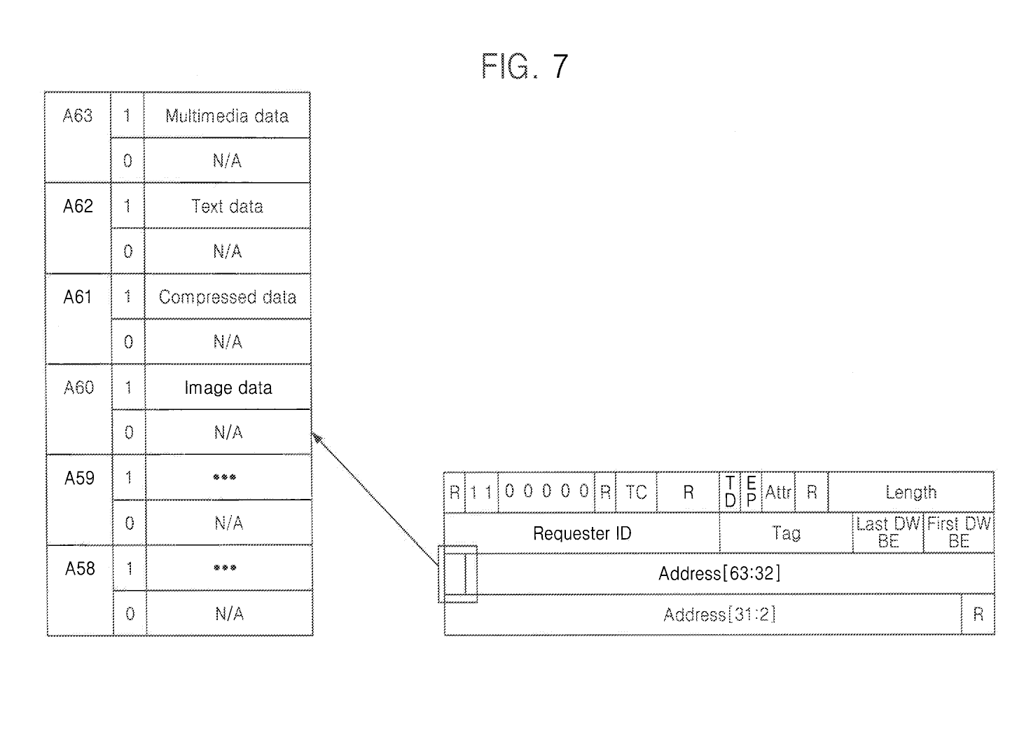

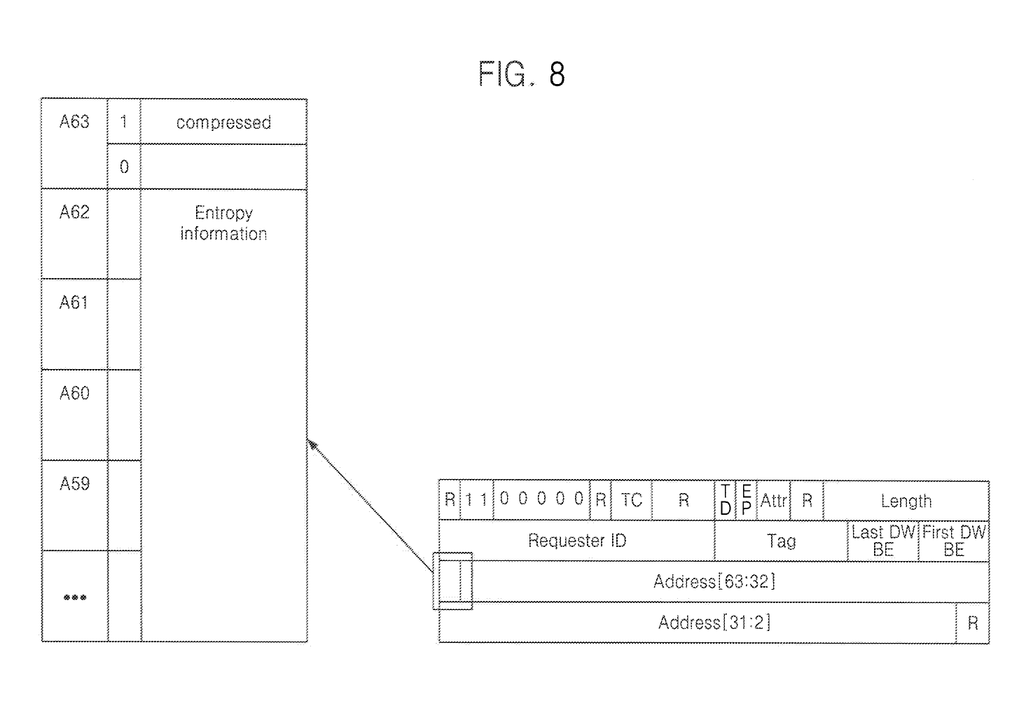

FIG. 6 is a diagram of a reserved field R in the header 133 illustrated in FIG. 5 according to some exemplary embodiments of the general inventive concept. FIG. 7 is a diagram of an address field in the header 133 illustrated in FIG. 5 according to some exemplary embodiments of the general inventive concept. FIG. 8 is a diagram of an address field in the header 133 illustrated in FIG. 5 according to other exemplary embodiments of the general inventive concept. Referring to FIGS. 1 through 8, data attribute information may be stored in a reserved bit allocated in a reserved field R in the header 133.

In other words, the host 20 may identify an extension of input data, e.g., multimedia data, text data, or image data, and store information about the attributes of the data, i.e., data attribute information in a reserved bit. Then, the controller 120 may detect whether the data has been compressed based on the data attribute information when analyzing the data.

However, when the reserved field R is already being used or has been inhibited, a portion of the address bits in the address field allocated for an address in the header 133 may be used, as illustrated in FIG. 7. In this case, the address and the data attribute information are stored in several of the upper most bits among the address bits, and the address and data attribute information may be transmitted together from the host 20 to the controller 120. Then, the controller 120 may identify the data attribute information by analyzing the upper most bits and identify the address using the remaining lower bits.

When it is detected that the host 20 includes an analysis function to determine whether data has been compressed, the host 20 may store information about whether the data has been compressed in an upper most bit among address bits, as illustrated in FIG. 8. The host 20 may also store entropy information of the data in the address field.

The entropy information indicates a maximum compression ratio. A compression ratio of data can be detected based on irregularity in the pattern of the data using the entropy information. For instance, the entropy information may have a value of 0, 1, 2, 3, 4, 5, or 6. In a case where a reference value is 6, when the entropy information has a value of 4, it is determined that additional compression can be performed on the data. When the entropy information has a value of at least 6, it is determined that the data cannot be further compressed.

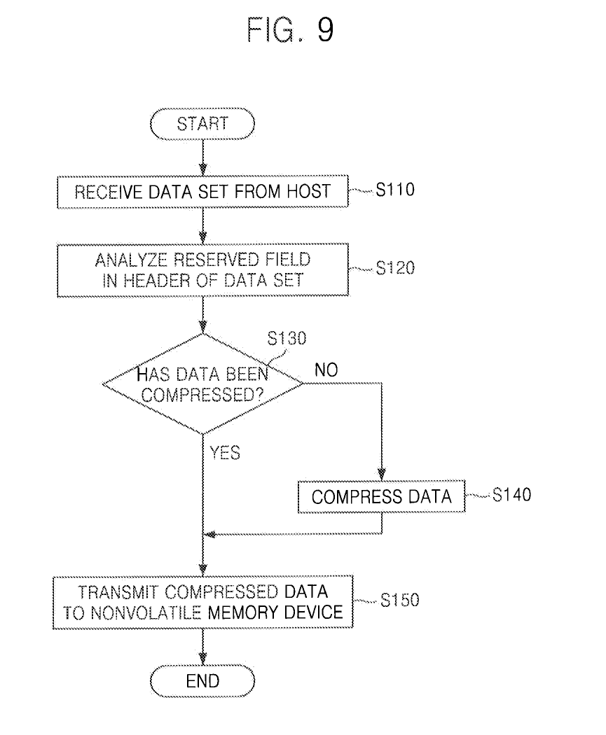

FIG. 9 is a flowchart of a method of processing data according to some exemplary embodiments of the general inventive concept. Referring to FIGS. 1 through 9, the controller 120 receives a data set from the host 20 in operation S110. At this time, the data set may include the header 133, the tag 135, and data to be stored in the nonvolatile memory device 110, as shown in FIG. 4B.

Next, a reserved field R in the header 133 of the data set is analyzed in operation S120. Based on a result of analyzing a reserved bit in the reserved field R of the header 133, it is detected whether data in the data set has been compressed in operation S130.

When it is detected that the data has not been compressed, the data is compressed using a predetermined compression algorithm (e.g., a lossless compression algorithm) in operation S140. The compressed data is transmitted to the nonvolatile memory device 110 in operation S150. However, when it is detected that the data has been compressed, the data is bypassed and transmitted to the nonvolatile memory device 110 in operation S150. Then, the nonvolatile memory device 110 receives the compressed data and stores the compressed data and information about whether the data has been compressed.

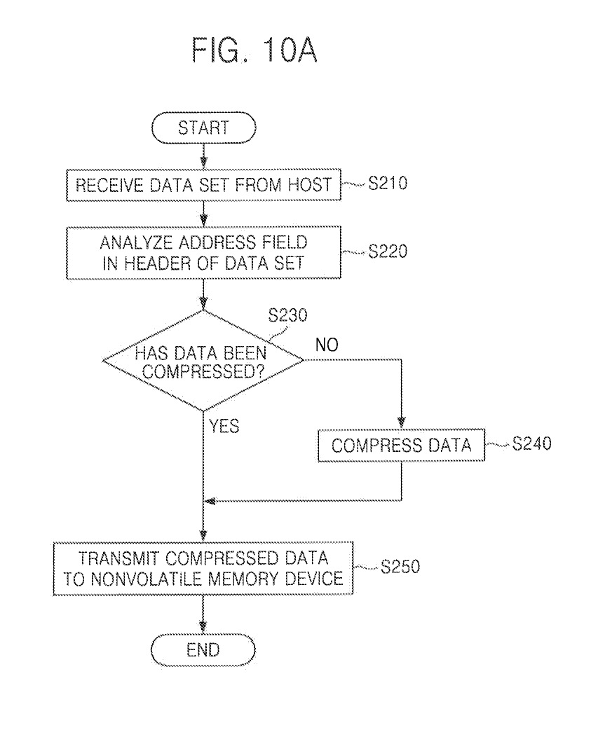

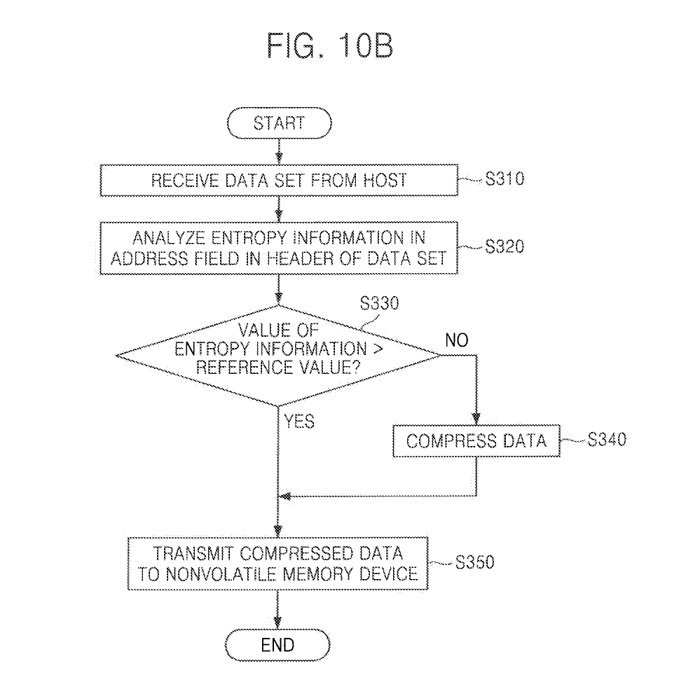

FIGS. 10A and 10B are flowcharts of methods of processing data according to other exemplary embodiments of the general inventive concept. Referring to FIGS. 1 through 8 and FIG. 10A, the controller 120 receives a data set from the host 20 in operation S210. An address field in the header 133 of the data set is analyzed in operation S220.

Based on a result of analyzing an address bit in the address field of the header 133, it is detected whether data in the data set has been compressed in operation S230. When it is detected that the data has not been compressed, the data is compressed using a predetermined compression algorithm (e.g., a lossless compression algorithm) in operation S240. The compressed data is transmitted to the nonvolatile memory device 110 in operation S250.

However, when it is detected that the data has been compressed, the data is bypassed and transmitted to the nonvolatile memory device 110 in operation S250. Then, the nonvolatile memory device 110 receives the compressed data and stores the compressed data and information about whether the data has been compressed.

In a case where the header 133 of a data set includes entropy information, the controller 120 receives the data set from the host 20 in operation S310, as illustrated in FIG. 10B. The entropy information included in an address bit of an address field in the header 133 of the data set is analyzed in operation S320.

Next, a value of the entropy information is compared with a predetermined reference value in operation S330. When the value of the entropy information is greater than the reference value, data in the data set is bypassed and transmitted to the nonvolatile memory device 110 in operation S350.

However, when the value of the entropy information is not greater than the reference value, the data is compressed using a compression algorithm in operation S340. The compressed data is transmitted to the nonvolatile memory device 110 in operation S350.

In other exemplary embodiments of the general inventive concept, any combination of the methods respectively illustrated in FIGS. 10A and 10B may be performed.

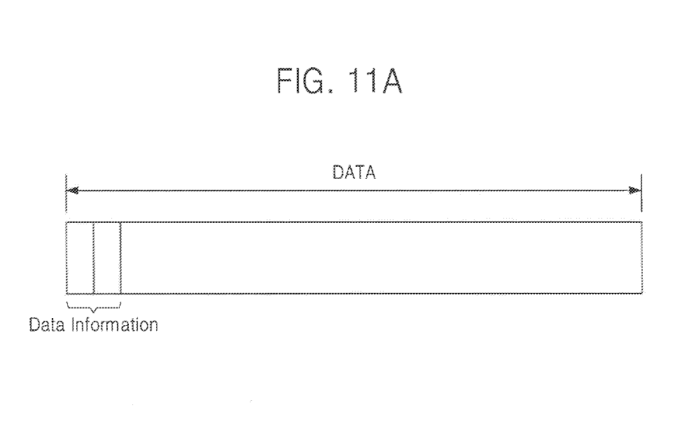

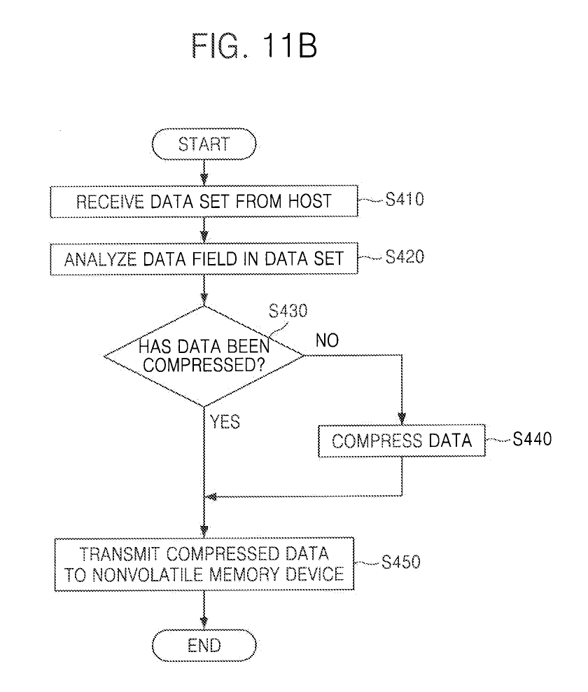

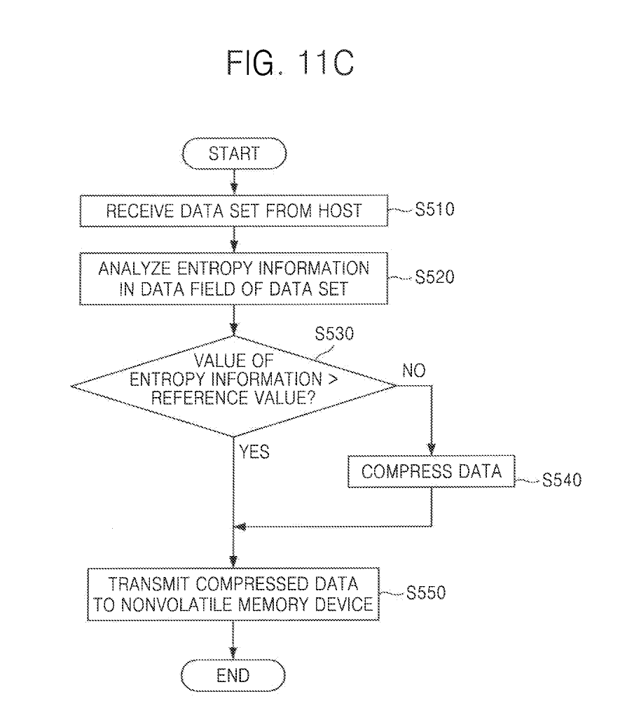

FIGS. 11A is a diagram for explaining a method of processing data according to further exemplary embodiments of the general inventive concept. Referring to FIGS. 3A through 10B, data attribute information is included in header information, address information, or tag information of data output from the host 20, when the data is transmitted from the host 20. Alternatively, as illustrated in FIG. 11A, a data set including data and data information in a data field DATA may be output from the host 20. In other words, when the data set is 512 bytes in length, for example, the data information indicating whether the data has been compressed is included in 2 bits in the data field DATA of the data set. Accordingly, the data attribute information may be determined based on a result of analyzing the data field DATA. Another example of a method of analyzing the attributes of data is illustrated in FIGS. 11B and 11C.

FIGS. 11B and 11C are flowcharts of the method illustrated in FIG. 11A. Referring to FIGS. 11A and 11B, the controller 120 receives a data set from the host 20 in operation S410. A data field DATA in the data set is analyzed in operation S420.

Next, based on a result of analyzing data information included in the data field DATA, whether data in the data set has been compressed is detected in operation S430. When it is detected that the data has not been compressed, the data is compressed using a lossless compression algorithm in operation S440. The compressed data is transmitted to the nonvolatile memory device 110 in operation S450.

However, when it is detected that the data has been compressed, the data is bypassed and transmitted to the nonvolatile memory device 110 in operation S450. Then, the nonvolatile memory device 110 receives the compressed data and stores the compressed data and information about whether the data has been compressed.

In a case where entropy information is included in the data field DATA of a data set, the controller 120 receives the data set from the host 20 in operation S510, as illustrated in FIG. 110. The entropy information included in the data field DATA of the data set is analyzed in operation S520.

Next, a value of the entropy information is compared with a predetermined reference value in operation S530. When the value of the entropy information is greater than the reference value, data in the data set is bypassed and transmitted to the nonvolatile memory device 110 in operation S550.

However, when the value of the entropy information is not greater than the reference value, the data is compressed using a lossless compression algorithm in operation S540. The compressed data is transmitted to the nonvolatile memory device 110 in operation S550.

FIG. 12 is a block diagram showing a modified example 150′ of the compressor 150 shown in FIG. 3A. While the analyzer 131 is provided outside the compressor 150 in FIG. 3A, an analyzer 131′ may be provided within the compressor 150′ as illustrated in FIG. 12.

Referring to FIG. 12, the analyzer 131′ may receive data from the host 20, analyze data information included in the data, and, based on a result of the analysis, output a compression control flag indicating whether the data has been compressed. The other elements illustrated in FIG. 12 are substantially the same as those illustrated in FIG. 3A. Thus, detailed descriptions thereof will be omitted.

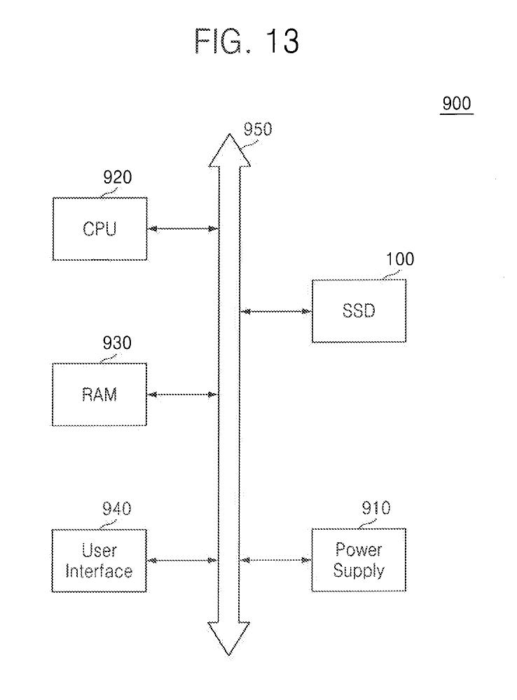

FIG. 13 is a block diagram of an electronic system including a data storage system according to some exemplary embodiments of the general inventive concept. Referring to FIG. 13, the electronic system 900 may include a data storage system 100, a power supply 910, a central processing unit (CPU) 920, a RAM 930, a user interface 940, and a system bus 950 electrically connecting these elements.

The CPU 920 controls the overall operation of the electronic system 900. The RAM 930 stores information needed for the operation of the electronic system 900. The user interface 940 provides an interface between the electronic system 900 and a user. The power supply 910 supplies electric power to the internal constituent elements such as the CPU 920, the RAM 930, the user interface 940, and the data storage system 100.

The CPU 920 may correspond to the host, and the data storage system 100 may store or read data in response to a command from the host. The data storage system 100 according to exemplary embodiments of the general inventive concept is described above, and thus a detailed description thereof will be omitted.

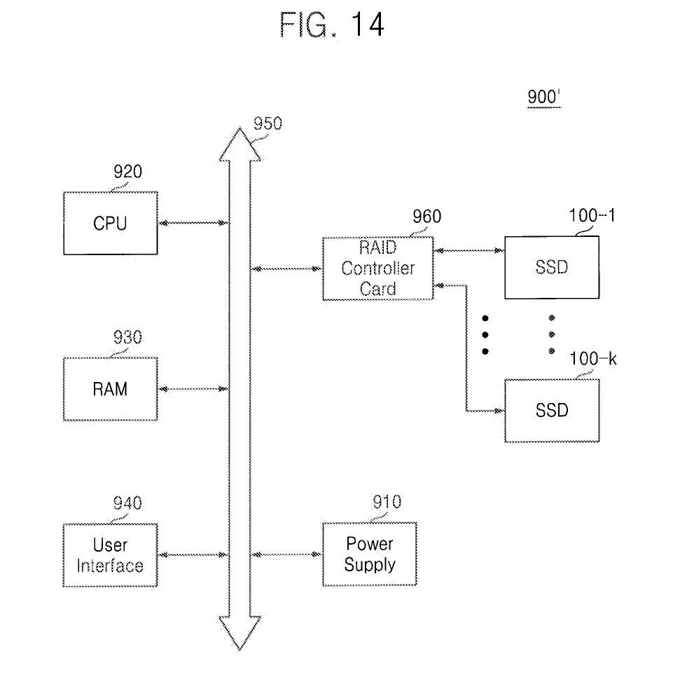

FIG. 14 is a block diagram of an electronic system including a data storage system according to other exemplary embodiments of the general inventive concept.

The electronic system 900′ as illustrated in FIG. 14 has a similar configuration to the electronic system 900 as illustrated in FIG. 13, so only differences there-between will be described.

The electronic system 900′ as illustrated in FIG. 14 further includes a RAID controller card 960. The RAID controller card 960 is connected between the host and the data storage system 100 to control the data storage system in compliance with the host. That is, the data storage system 100 is installed into the RAID controller card 960 and communicates with the host via the RAID controller card 960. In this case, a plurality of data storage systems 100-1 through 100-k may be installed into the RAID controller card 960.

The RAID controller card 960 illustrated in FIG. 14 may be implemented as a separate product external of the plurality of data storage systems 100-1 through 100-k.

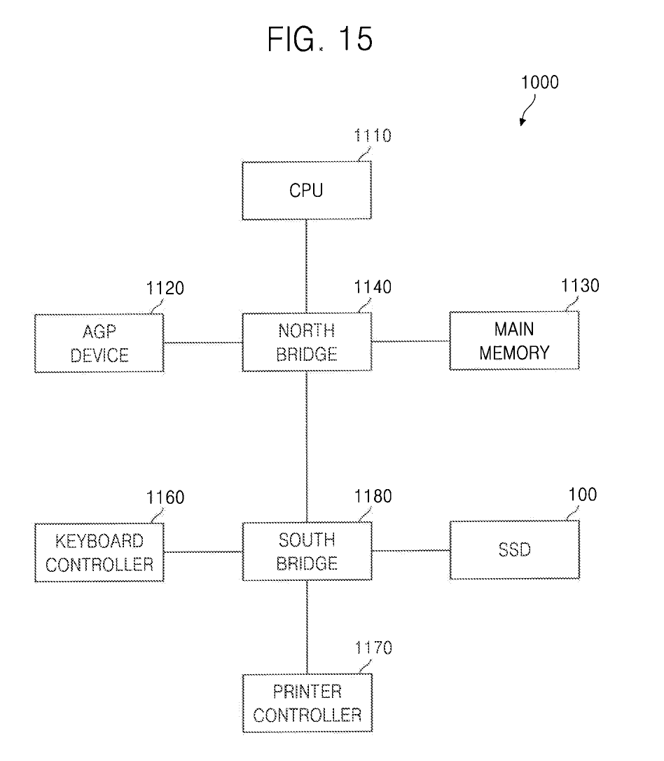

FIG. 15 is a block diagram of a computer system including a data storage system according to some exemplary embodiments of the general inventive concept. The computer system 1000 includes a computer CPU (central processing unit) 1110, an AGP (accelerated graphics port) device 1120 and a main memory 1130 coupled to the computer CPU 1110 via a north bridge 1140. The computer system 1000 further includes a keyboard controller 1160, a printer controller 1170, and the data storage system 100 coupled to the computer CPU 1110 via a south bridge 1180 and the north bridge 1140. The components 1110, 1120, 1130, 1140, 1160, 1170, and 1180 of the PC system 1000 are generally and individually known to one of ordinary skill in the art. The computer system maybe, for example, a PC (personal computer) system, or a notebook computer, in which the SSD is used as a main storage device instead of hard disk drive. However, the general inventive concept is not restricted thereto.

The present general inventive concept may be implemented in hardware, software, or combination thereof. The present general inventive concept can also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, according to some embodiments of the present invention, a data storage system detects whether input data has been compressed before compressing the data, thereby reducing its operating time and increasing the effect of data compression.

While the present invention has been particularly shown and described with reference to exemplary embodiments thereof, it will be understood by those of ordinary skill in the art that various changes in forms and details may be made therein without departing from the spirit and scope of the present invention as defined by the following claims.

What is claimed is:

1. A data storage system comprising:
a controller configured to receive data and data information about the data from a host, analyze the data information, detect whether the data has been compressed, and compress the data according to a detection result; and
a nonvolatile memory device configured to store the data compressed by the controller and information about whether the data has been compressed,
wherein the controller comprises:
a buffer configured to temporarily store the data and the data information received from the host;
an analyzer configured to output, based on an analysis result, a compression control flag that indicates whether the data has been compressed; and
a compressor configured to selectively compress or bypass the data based on the compression control flag, and to transmit the data to the nonvolatile memory device.

2. The data storage system of claim 1, wherein the compressor comprises:
a register configured to store the compression control flag output from the analyzer;
a selector configured to bypass and transmit the data to the nonvolatile memory device in response to the compression control flag stored in the register when it is detected that the data has been compressed and to output the data to an internal component of the compressor in response to the compression control flag when it is detected that the data has not been compressed; and
a processor configured to compress the data output from the selector using a predetermined compression algorithm and to transmit the compressed data to the nonvolatile memory device.

3. The data storage system of claim 2, wherein the predetermined compression algorithm is one of a deflate algorithm, a Huffman algorithm, an arithmetic coding algorithm, and a Lempel-Ziv-Welch (LZW) algorithm.

4. The data storage system of claim 1, wherein a header of the data is transmitted from the host before the data is transmitted, and the analyzer analyzes attributes of the data based on the data information included in the header or the data.

5. The data storage system of claim 4, wherein the header comprises a reserved field and an address field, and the analyzer analyzes the reserved field in the header and outputs the compression control flag that indicates whether the data has been compressed to the compressor.

6. The data storage system of claim 4, wherein the header comprises a reserved field and an address field, and the analyzer analyzes the address field in the header and outputs the compression control flag that indicates whether the data has been compressed to the compressor.

7. The data storage system of claim 6, wherein the address field comprises entropy information and the analyzer is configured to compare a value of the entropy information with a predetermined reference value, and to output the compression control flag to the compressor based on a comparison result of the entropy information and the predetermined reference value.

8. The data storage system of claim 1, wherein a tag of the data is transmitted from the host after the data is transmitted, and the analyzer outputs the compression control flag that indicates whether the data has been compressed to the compressor based on the tag of the data.

9. The data storage system of claim 1, wherein the data information is information that directly indicates whether the data has been compressed.

10. The data storage system of claim 1, wherein the data information is attribute information indicating whether the data is multimedia data, text data, or image data, and indirectly indicates whether the data has been compressed.

11. The data storage system of claim 1, wherein the data storage system is a solid state disk, a solid state drive, or a memory card.

12. A memory controller comprising:
a buffer configured to temporarily store data received from a host;
an analyzer configured to analyze data information about the data received from the host and detect whether the data has been compressed based on a result of the analysis; and
a compressor configured to selectively compress or bypass the data based on a result of the detection of the analyzer, and to transmit the data to a nonvolatile memory device where the data is stored therein.

13. The memory controller of claim 12, wherein the analyzer outputs a compression control flag according to the detection result, and
the compressor comprises:
a register configured to store the compression control flag output from the analyzer;
a selector configured to bypass and transmit the data to the nonvolatile memory device in response to the compression control flag stored in the register when it is detected that the data has been compressed and to output the data to an internal component of the compressor in response to the compression control flag when it is detected that the data has not been compressed; and
a processor configured to compress the data output from the selector using a predetermined compression algorithm, and to transmit the compressed data to the nonvolatile memory device.

14. The memory controller of claim 12, wherein the data information is comprised in one of a header of the data, the data, and a tag of the data.

15. A data processing method, comprising:
receiving data and data information from a host;
analyzing the data and the data information to determine whether the data has been compressed;
when it is determined that the data has not been compressed, compressing the data using a predetermined compression algorithm and transmitting the compressed data to a nonvolatile memory device; and
when it is determined that the data has been compressed, transmitting the data to the nonvolatile memory device.

16. The data processing method of claim 15, wherein the data includes a header having a reserved field and an address field, and wherein the analyzing of the data and the data information includes analyzing one of the reserved field and the address field to determine whether the data has been compressed.

17. The data processing method of claim 15, wherein
the data includes a header having a reserved field and an address field,
the address field includes entropy information, and wherein
the analyzing of the data and the data information includes comparing a value of the entropy information with a predetermined entropy reference value; and
the determination of whether the data has been compressed is based on the comparison of the value of the entropy information and the predetermined entropy value.

18. The data processing method of claim 15, further comprising receiving a tag of the data, wherein the analyzing of the data and the data information includes analyzing the tag of the data to determine whether the data has been compressed.

19. The data processing method of claim 15, wherein
the data includes a plurality of bytes,
a portion of the plurality of bytes of the data includes information indicating whether the data has been compressed, and wherein
the analyzing of the data and the data information includes analyzing the portion of the plurality of bytes of the data to determine whether the data has been compressed.

20. A non-transitory recording medium for recording a program for executing the data processing method of claim 15.
